(19) United States
(12) Patent Application Publication
(10) Pub. No.: US 2026/0200958 A1
(43) Pub. Date: Jul. 16, 2026

(54) IODOALKYL TIN COMPOUNDS AND PREPARATION METHODS THEREOF

(71) Applicants: Gelest, Inc., Morrisville, PA (US); Mitsubishi Chemical Corporation, Tokyo (JP)

(72) Inventor: Li YANG, Belle Mead, NJ (US)

(21) Appl. No.: 19/557,388

(22) Filed: Mar. 5, 2026

Related U.S. Application Data
(62) Division of application No. 18/372,922, filed on Sep. 26, 2023, now Pat. No. 12,606,577.
(60) Provisional application No. 63/410,692, filed on Sep. 28, 2022.
(60) Provisional application No. 63/411,681, filed on Sep. 30, 2022.

(51) Int. Cl. C07F 7/22

(52) U.S. Cl. CPC C07F 7/2224

(57) ABSTRACT

Methods for synthesizing iodoalkyl tin trialkoxide and diiodoalkyl tin trialkoxide compounds having the chemical formulas R′Sn(OR)₃ and R″Sn(OR)₃ are described. R′ is a primary or secondary iodoalkyl group having about 2 to about 10 carbon atoms and containing at least one iodine atom, R″ is a primary or secondary iodoalkyl group having about 2 to about 10 carbon atoms and containing two iodine atoms, and R is a primary, secondary, or tertiary alkyl group having about 1 to about 5 carbon atoms. The iodoalkyl tin compounds may be used for the formation of high-resolution EUV lithography patterning precursors and are attractive due to their desirable purity and low concentration of bisiodoalkyl and bisdiioodoalkyl impurities.

### CROSS-REFERENCE TO RELATED APPLICATIONS

This application claims priority to U.S. Provisional Application No. 63/410,692, filed Sep. 28, 2022, and U.S. Provisional Application No. 63/411,681, filed Sep. 30, 2022, the disclosures of which are herein incorporated by reference in their entireties.

### BACKGROUND OF THE INVENTION

As semiconductor fabrication continues to advance, feature sizes continue to shrink, driving the need for new processing methods. Certain organotin compounds have been shown to be useful in the deposition of tin oxide hydroxide coatings in applications such as extreme ultraviolet (EUV) lithography techniques. Iodine has a particularly high cross section in the EUV range, which is due to delayed absorption by its 4d orbital. As a result, iodine-substituted compounds have been shown to exhibit much higher photoelectron spectrum intensity caused by the existence of core levels at favorable energy position and the formation of photoelectrons with favor low electron energies. (Nanomaterials 10, 1593 (2020)). Iodine-substituted alkyl tin compounds have drawn high attention as EUV photoresist candidates which can be used to pattern structures lithographically.

Known methods for preparing iodoalkyl tin compounds inevitably lead to mixtures of different products, and the ability to prepare and isolate iodoalkyl tin compounds having desired purity levels has not previously been reported. Such tin compounds would be very attractive for use in the microelectronic industry.

### SUMMARY OF THE INVENTION

In one embodiment, aspects of the disclosure relate to an iodoalkyl tin trialkoxide compound having formula (1):

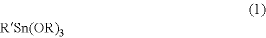

wherein R′ is a primary or secondary iodoalkyl group having about 2 to about 10 carbon atoms and containing at least one iodine atom and R is a primary, secondary, or tertiary alkyl group having about 1 to about 5 carbon atoms.

In a second embodiment, aspects of the disclosure relate to a diiodoalkyl tin trialkoxide compound having formula (2):

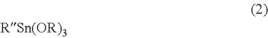

wherein R″ is a primary or secondary iodoalkyl group having about 2 to about 10 carbon atoms and containing two iodine atoms and R is a primary, secondary, or tertiary alkyl group having about 1 to about 5 carbon atoms.

In a third embodiment, aspects of the disclosure relate to a method of synthesizing an iodoalkyl tin trialkoxide compound having formula (1):

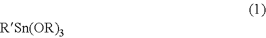

wherein R′ is a primary or secondary iodoalkyl group having about 2 to about 10 carbon atoms and containing at least one iodine atom and R is a primary, secondary, or tertiary alkyl group having about 1 to about 5 carbon atoms, the method comprising:
   (a) providing a solution of an alkenyl tin trichloride;
   (b) adding a borane solution;
   (c) adding solid iodine or an iodine solution; and
   (d) adding a solution of an alkali metal alkoxide to yield a product containing an iodoalkyl tin trialkoxide having formula (1).

In a fourth embodiment, aspects of the disclosure relate to a method of synthesizing a diiodoalkyl tin trialkoxide compound having formula (2):

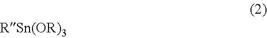

wherein R″ is a primary or secondary iodoalkyl group having about 2 to about 10 carbon atoms and containing two iodine atoms and R is a primary, secondary, or tertiary alkyl group having about 1 to about 5 carbon atoms, the method comprising:
   (a) providing a solution of an alkenyl tin trialkoxide; and
   (b) adding solid iodine or an iodine solution to yield a product containing a diiodoalkyl tin trialkoxide having formula (2).

In a fifth embodiment, aspects of the disclosure relate to an iodoalkyl tin trialkoxide compound having formula (1):

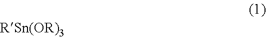

wherein R′ is a primary or secondary iodoalkyl group having about 2 to about 10 carbon atoms and containing at least one iodine atom and R is a primary, secondary, or tertiary alkyl group having about 1 to about 5 carbon atoms, wherein the compound having formula (1) is produced by a method comprising:
   (a) providing a solution of an alkenyl tin trichloride;
   (b) adding a borane solution;
   (c) adding solid iodine or an iodine solution; and
   (d) adding a solution of an alkali metal alkoxide to yield a product containing an iodoalkyl tin trialkoxide having formula (1).

In a sixth embodiment, aspects of the disclosure relate to a diiodoalkyl tin trialkoxide compound having formula (2):

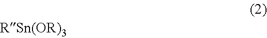

wherein R″ is a primary or secondary iodoalkyl group having about 2 to about 10 carbon atoms and containing two iodine atoms and R is a primary, secondary, or tertiary alkyl group having about 1 to about 5 carbon atoms, wherein the compound having formula (2) is produced by a method comprising:
   (a) providing a solution of an alkenyl tin trialkoxide; and
   (b) adding solid iodine or an iodine solution to yield a product containing a diiodoalkyl tin trialkoxide having formula (2).

### DETAILED DESCRIPTION OF THE INVENTION

According to one aspect of the disclosure, provided are iodoalkyl tin trialkoxide compounds represented by formula (1). In a preferred embodiment, the compounds having formula (1) have a purity of at least about 99 mol %, as described in more detail below. In a preferred embodiment, the compounds having formula (1) contain minimal amounts of bisiodoalkyl tin compounds having formula (3) relative to the total amount of tin, such as less than about 1 mol %.

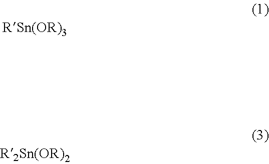

In formulas (1) and (3), R′ is a primary or secondary iodoalkyl group having about 2 to about 10 carbon atoms and containing at least one iodine atom and R is a primary, secondary, or tertiary alkyl group having about 1 to about 5 carbon atoms. Preferably, R′ contains about 2 to about 6 carbon atoms, more preferably about 2 to about 3 carbon atoms, and is most preferably iodoethyl, iodopropyl, or iodoisopropyl, and R may be a primary, secondary, or tertiary alkyl group such as ethyl, propyl, isopropyl, t-butyl, or t-pentyl. In preferred embodiments R′ contains at least one iodine atom substituted on a terminal carbon atom. In preferred embodiments, R′ contains at least one iodine atoms substituted on a carbon atom which is at least two carbon atoms away from the tin atom. In preferred embodiments, R′ contains at least two iodine atoms. In preferred embodiments, the at least two iodine atoms are on vicinal (adjacent) carbon atoms.

In another aspect of the disclosure, provided are diiodoalkyl tin trialkoxide compounds represented by the chemical formula (2). In a preferred embodiment, the compounds having formula (2) have a purity of at least about 99 mol %, as described in more detail below. In a preferred embodiment, the compounds having formula (2) contain minimal amounts of bisdiiodoalkyl tin compounds having formula (4) relative to the total amount of tin, such as less than about 1 mol %.

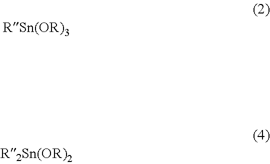

In formulas (2) and (4), R″ is a primary or secondary diiodoalkyl group having about 2 to about 10 carbon atoms and two iodine atoms and R is a primary, secondary, or tertiary alkyl group having about 1 to about 5 carbon atoms. Preferably, R″ contains about 2 to about 6 carbon atoms, more preferably about 2 to about 3 carbon atoms, and is most preferably diiodoethyl, diiodopropyl, or diiodoisopropyl and R can be a primary, secondary, or tertiary alkyl group such as ethyl, propyl, isopropyl, t-butyl, or t-pentyl. In preferred embodiments R″ contains at least one iodine atom substituted on a terminal carbon atom. In preferred embodiments, R″ contains at least one iodine atoms substituted on a carbon atom which is at least two carbon atoms away from the tin atom. In preferred embodiments, the at least two iodine atoms in R″ are on vicinal (adjacent) carbon atoms.

Further aspects of the disclosure relate to methods for producing iodoalkyl tin trialkoxide compounds represented by formula (1) and to compounds having formula (1) produced by the method. In a preferred embodiment, the compounds having formula (1) contain minimal bisiodoalkyl tin compounds having formula (3) relative to the total amount of tin, such as less than about 1 mol %.

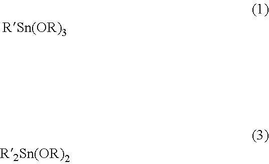

In formulas (1) and (3), R′ is a primary or secondary iodoalkyl group having about 2 to about 10 carbon atoms and at least one iodine atom and R is a primary, secondary, or tertiary alkyl group having about 1 to about 5 carbon atoms as previously described. Preferably, R′ is iodoethyl, iodopropyl, or iodoisopropyl and R may be a primary, secondary, or tertiary alkyl group such as ethyl, propyl, isopropyl, t-butyl, or t-pentyl.

Other aspects of the disclosure relate to methods for producing diiodoalkyl tin trialkoxide compounds represented by the chemical formula (2) and to compounds having formula (2) produced by the method. In a preferred embodiment, the compounds having formula (2) contain minimal bisdiiodoalkyl tin compounds having formula (4) relative to the total amount of tin, such as less than about 1 mol %.

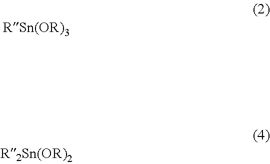

In formulas (2) and (4), R′ is a primary or secondary diiodoalkyl group having about 2 to about 10 carbon atoms and two iodine atoms and R is a primary, secondary, or tertiary alkyl group having about 1 to about 5 carbon atoms as previously described. Preferably, R′ is diiodoethyl, diiodopropyl, or diiodoisopropyl and R can be a primary, secondary, or tertiary alkyl group such as ethyl, propyl, isopropyl, t-butyl, or t-pentyl.

Exemplary compounds having formulas (1) and (2) contain iodoethyl, diiodoethyl, iodoisopropyl, and diiodoisopropyl substituents, as shown below, where X is an OR group. Preferred compounds having formulas (1) and (2) have at least one terminal iodine atom, which provides suitable reactivity for EUV lithography. Preferably, the carbon atom containing the iodine substitution is more than two carbon atoms removed from the tin atom, as this provides high stability. Diiodoalkyl tin trialkoxide compounds are more preferred due to higher sensitivity for EUV light exposure.

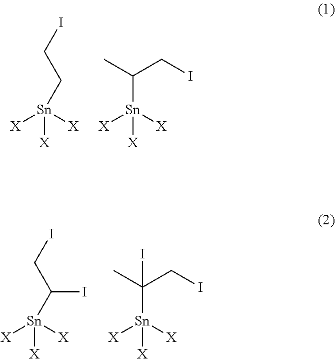

In preferred embodiments, the compounds having formulas (1) and (2) have high purity, such as those having purities of greater than about 95 mol %, greater than about 97 mol %, greater than about 98 mol %, greater than about 99 mol %, or even higher. These compounds contain low or minimal levels of, or, in some embodiments, are substantially free of, bisiodoalkyl and bisdiiodoalkyl tin compounds having formulas (3) and (4), respectively, which may, in some embodiments, be as low as 1 mol %, such as less than about 1 mol %, less than about 0.9 mol %, less than about 0.8 mol %, less than about 0.7 mol %, less than about 0.6 mol %, less than about 0.5 mol %, less than about 0.4 mol %, less than about 0.3 mol %, less than about 0.2 mol %, or less than about 0.1 mol %. All numerical ranges expressed in this disclosure encompass all values within the range, including fractional and decimal amounts.

For the purposes of this disclosure, the term “high purity” may be understood to mean a purity greater than about 99 mol %, more preferably greater than about 99.2 mol %, even more preferably greater than about 99.3 mol %. The term “substantially free” may be understood to mean that the impurity is not detectable by ¹¹⁹Sn NMR, which can have detection limits as low as 0.05 mol % when testing the sample without dilution in deuterated solvent.

¹¹⁹Sn NMR spectroscopy is ideally suited to the quantitative analysis of iodoalkyl tin compounds due to its high sensitivity to small structural changes and large spectral range of 6500 ppm (see Davies et al., Eds.; Tin Chemistry: Fundamentals, Frontiers, and Applications; Wiley (2008)). This allows for easy identification and quantification of iodoalkyl tin compounds and their impurities because ¹¹⁹Sn resonances are highly resolved. ¹¹⁹Sn NMR suffers from reduced sensitivity compared to other analytical methods such as GC, HPLC, or ¹H NMR. To improve sensitivity, iodoalkyl tin compounds are analyzed without dilution, and a large number of spectral acquisitions (2000+) are acquired to measure the low levels of impurities described in this work. Using this approach, detection limits of 500 ppm diiodoalkyl tin dialkoxides can be achieved.

The ¹¹⁹Sn NMR data described herein were obtained using a method similar to the relative purity method described in J. Med. Chem. (57, 22, 9220-9231 (2014)). ¹¹⁹Sn NMR spectra were acquired using inverse-gated ¹H decoupling with a 40° pulse, one second relaxation delay, and sufficient scans to achieve the required sensitivity. Samples were prepared without dilution in deuterated solvent. Quantitation was performed by integrating all peaks in the spectrum and setting the total peak area to 100. Each peak in the spectrum represents a distinct tin compound and the area of each peak represents the concentration or purity of that compound in mol %.

In some embodiments, the compounds having formula (1) and formula (2) have a total content of tetrakis(dialkoxy) tin of less than about 1 mol %, a total content of distannane compounds of less than about 1 mol %, and/or a content of tetraiodoalkyl tin of less than about 1 mol %. These contents may each independently be less than about 0.9 mol %, less than about 0.8 mol %, less than about 0.7 mol %, less than about 0.6 mol %, less than about 0.5 mol %, less than about 0.4 mol %, less than about 0.3 mol %, less than about 0.2 mol %, less than about 0.1 mol %, or even lower.

The organometallic tin compounds having formulas (1) and (2) may be used for the formation of high-resolution EUV lithography patterning precursors and are attractive due to their purity and minimized concentrations of bisiodoalkyl and bisdiiodoalkyl impurities having formulas (3) and (4), respectively, as well as additional impurities.

### Methods of Synthesis

Aspects of the disclosure relate to methods for synthesizing the iodoalkyl and diidoalkyl tin compounds having formula (1) and (2) described above which are suitable for use in the microelectronic industry. These compounds may be prepared in high purity, such as those having purities of greater than about 95 mol %, greater than about 97 mol %, greater than about 98 mol %, greater than about 99 mol %, or even higher. These compounds contain low or minimal levels of, or, in some embodiments, are substantially free of, bisiodoalkyl and bisdiiodoalkyl tin compounds having formulas (3) and (4), respectively, which may, in some embodiments, be as low as 1 mol %, such as less than about 1 mol %, less than about 0.9 mol %, less than about 0.8 mol %, less than about 0.7 mol %, less than about 0.6 mol %, less than about 0.5 mol %, less than about 0.4 mol %, less than about 0.3 mol %, less than about 0.2 mol %, less than about 0.1 mol %, or even lower.

In some embodiments, the compounds having formula (1) and formula (2) have a total content of tetrakis(dialkoxy) tin of less than about 1 mol %, a total content of distannane compounds of less than about 1 mol %, and/or a content of tetraiodoalkyl tin of less than about 1 mol %. These contents may each independently be less than about 0.9 mol %, less than about 0.8 mol %, less than about 0.7 mol %, less than about 0.6 mol %, less than about 0.5 mol %, less than about 0.4 mol %, less than about 0.3 mol %, less than about 0.2 mol %, less than about 0.1 mol %, or even lower.

Methods for preparing iodoalkyl tin trialkoxide compounds having formula (1) in high yield involve the hydroboration-iodination of the corresponding alkenyl-substituted tin trichloride followed by reaction with a base. For example, appropriate starting materials include vinyl tin trichloride, allyl tin trichloride, isopropenyl tin trichloride, etc.; the double bond in the alkenyl substituent must be in the terminal position with respect to tin. Hydroboration followed by iodination of the alkene results in the formation of an organoborane and then an anti-Markovnikov hydroiodination so that the iodine in the alkyl iodide substituent is in the terminal position with respect to tin. As explained below, appropriate borating agents include, without limitation, borane (BH₃) and disiamylborane ((bis(1,2-dimethylpropyl) borane, Sia₂BH), which has been found to result in a more quantitative hydroiodination in the second step. Finally, the chlorine substituents on the tin are converted to alkoxy groups via reaction with a base in the presence of an alcohol, such as methanol for formation of a tin trimethoxide compound. Appropriate bases include alkali metal alkoxides, such as the presently preferred sodium t-butoxide.

Methods for preparing diiodoalkyl tin trialkoxide compounds having formula (2) in high yield involve the direct iodination of the corresponding alkenyl-substituted tin trialkoxide in the presence of acetonitrile or an alcohol. For example, appropriate starting materials include vinyl tin trialkoxide, allyl tin trialkoxide, isopropenyl tin trialkoxide, etc.; iodination of the alkene results in the formation of a diiodoalkyl group.

A method for preparing an iodoalkyl tin trialkoxide compound having formula (1) according to aspects of the disclosure involves the following steps, each of which is described in further detail below:
(a) providing a solution of an alkenyl tin trichloride;
(b) adding a borane solution;
(c) adding solid iodine or an iodine solution; and
(d) adding an alcoholic solution of an alkali metal alkoxide to yield a product containing iodoalkyl tin trialkoxide having formula (1).

While the order of steps is preferably (a), (b), (c), and then (d) to avoid side reactions, it is also within the scope of the disclosure to perform step (d) between steps (a) and (b).

The first step involves preparing a solution of an alkenyl tin trichloride preferably in an ether solvent such as THF or diethyl ether. The appropriate alkenyl tin trichloride is determined by the desired final product, and may include, for example, vinyl tin trichloride, allyl tin trichloride, isopropenyl tin trichloride, etc.; the double bond in the alkenyl substituent must be in the terminal position with respect to tin.

The concentration of the alkenyl tin trichloride in the solution is preferably up to about 30 wt %, more preferably up to about 20 wt %, even more preferably up to about 15 wt %, and preferably greater than about 1 wt %, greater than about 2 wt %, greater than about 3 wt %, even more preferably greater than about 5 wt %. It has been found that this dilute concentration provides effective control of the reaction temperature and solubility of the alkenyl tin trichloride. On the other hand, the productivity is lower in dilute concentrations in industrial conditions.

In the second step, a solution of a borane such as BH₃ or disiamylborane is added to the alkenyl tin trichloride solution preferably at a temperature of about 0 to 10° C., preferably in a drop-wise fashion. For example, a 2.0 M. 2.5 M, or 3.0M solution of borane in THE may be appropriate, but the particular solvent and concentration may be determined based on availability and provided that the desired stoichiometry of borane to alkenyl tin trichloride is achieved. Specifically, the amount of alkenyl tin trichloride is at least about 3 equivalents relative to the amount of hydrides in the borane, such as about 3.05 equivalents, about 3.10 equivalents, about 3.15 equivalents, etc. If the borane is BH₃, it is provided in a 1:3 molar ratio relative to the alkenyl tin trichloride, whereas if the borane is disiamylborane, it is provided in an approximately 1:1 molar ratio.

Following the borane addition, the reaction mixture is allowed to slowly warm to room temperature, then stirred for an additional time period at room temperature, such as for about 2 hours. It is within the scope of the disclosure to add an alcohol such as t-butanol at this stage to destroy traces of residual hydride. Next, solid iodine or an iodine solution is added, followed by a dropwise addition of an alkali metal alkoxide, such as sodium t-butoxide, in an alcohol, such as t-butanol, preferably dropwise over about a one-hour period at about 0 to 10° C., yielding a product containing iodoalkyl tin trialkoxide having formula (1).

The molar amount of iodine (I₂) relative to alkenyl tin trichloride is preferably greater than about 0.9 equivalents, or greater than about 1.0 equivalents, and less than about 2.0 equivalent, less than about 1.8 equivalents, less than about 1.6 equivalents, more preferably less than about 1.4 equivalents. If the amount of iodine is too low, starting materials may remain. Also, the reaction speed may be too low and the amount of impurities may increase due to side reactions such as redistribution. If the amount of iodine is too high, overreaction may occur and increase poly-iodine-substituted byproducts.

If the iodine is used in solution, the solvent is preferably an ether solvent, such as THF or diethyl ether, or an alcohol, such as t-butanol. The concentration of the iodine is preferably up to about 30 wt %, more preferably up to about 20 wt %, or up to about 15 wt % and preferably greater than about 1 wt %, greater than about 2 wt %, greater than about 3 wt %, even more preferably greater than about 5 wt %. It has been found that this dilute concentration provides effective control of the reaction temperature. On the other hand, the productivity is lower in dilute concentrations in industrial conditions.

Finally, the crude mixture is extracted, such as with hexanes, and the solvents are removed under vacuum to produce a crude product which is distilled, preferably under vacuum, to produce the desired compound having formula (1). Specifically, the crude product may be distilled at about 1 torr, discarding any distillate before the boiling point of the iodoalkyl tin trialkoxide having formula (1), and collecting only the distillate obtained at the boiling point of the iodoalkyl tin trialkoxide having formula (1) to yield a product containing iodoalkyl tin trialkoxide having formula (1). Appropriate distillation conditions may be determined by routine experimentation depending on the specific iodoalkyl tin trialkoxide compound.

A method for preparing a diiodoalkyl tin trialkoxide compound having formula (2) according to aspects of the disclosure involves the following steps, each of which is described in further detail below:
(a) providing a solution of an alkenyl tin trialkoxide; and
(b) adding solid iodine or an iodine solution to yield a product containing diiodoalkyl tin trialkoxide having formula (2).

The first step involves preparing a solution of an alkenyl tin trialkoxide, preferably in an acetonitrile or an alcohol solvent. The appropriate alkenyl tin trialkoxide is determined by the desired final product, and may include, for example, vinyl tin trialkoxide, allyl tin trialkoxide, isopropenyl tin trialkoxide, etc. The alkenyl tin trialkoxide may be obtained by known methods. If an alcohol is employed as a solvent, the particular alcohol is determined by the alkoxide which is employed. For example, if the alkoxide is vinyl tin trialkoxide, appropriate alcohols include, without limitation, methanol, ethanol, isopropanol, t-butanol, and 2-methylbutan-2-ol.

The concentration of the alkenyl tin trialkoxide in the solution is preferably up to about 30 wt %, more preferably up to about 20 wt %, or up to about 15 wt % and preferably greater than about 1 wt %, greater than about 2 wt %, greater than about 3 wt %, even more preferably greater than about 5 wt %. It has been found that this dilute concentration provides effective control of the reaction temperature and solubility of the alkenyl tin trichloride. On the other hand, the productivity is lower in dilute concentrations in industrial conditions.

In the second step, solid iodine or an iodine solution is added to the solution preferably at a temperature of about 0° C. to about 10° C. at a ratio of about 1:1 relative to the amount of alkenyl tin trialkoxide. Following the addition, the reaction mixture is allowed to warm to room temperature and stirred for an additional period of time until the yellow color has disappeared, thereby yielding a product containing diiodoalkyl tin trialkoxide having formula (2).

If the iodine is used in solution, the solvent is preferably an ether solvent, such as THE or diethyl ether, or an alcohol, such as t-butanol. The concentration of the iodine is preferably up to about 30 wt %, more preferably up to about 20 wt %, or up to about 15 wt % and preferably greater than about 1 wt %, greater than about 2 wt %, greater than about 3 wt %, even more preferably greater than about 5 wt %. It has been found that this dilute concentration provides effective control of the reaction temperature. On the other hand, the productivity is lower in dilute concentrations in industrial conditions.

Preferably, the acetonitrile, alcohol, and/or ether solvents are removed under vacuum to produce a crude product which is distilled, preferably under vacuum, to produce the desired compound having formula (2). Specifically, the crude product is distilled at about 1 torr, discarding any distillate before the boiling point of the diiodoalkyl tin trialkoxide having formula (2), and collecting only the distillate obtained at the boiling point of the diiodoalkyl tin trialkoxide having formula (2) to yield a product containing diiodoalkyl tin trialkoxide having formula (2). Appropriate distillation conditions may be determined by routine experimentation depending on the specific iodoalkyl tin trialkoxide compound.

All of the method steps for the syntheses of the compounds having formula (1) and formula (2) are preferably performed substantially without light exposure which has detrimental effects on the iodoalkyl tin trialkoxide compounds; the iodoalkyl structure is easy decomposed by exposure to light. Shielding may be accomplished by any method known in the art such as, for example, employing light-shielded containers such as amber glass, metal (SUS) containers, wrapping the container with a light-shielding cover such as cloth, foil or film, using light-shielding coatings, or performing the reactions in a dark room.

The distillations may be performed using a stainless steel column packed with a stainless steel packing material. Alternatively, the distillations may be performed in a light-shielded apparatus comprising glass such as glass equipment, glass-lined equipment, glass-coated equipment, etc. Shielding may be accomplished by any method known in the art such as, for example, employing light-shielded containers such as amber glass, metal (SUS) containers, wrapping the container with a light-shielding cover such as cloth, foil or film, using light-shielding coatings, or performing the distillation in a dark room.

Further aspects of the disclosure relate to a solution containing an organic solvent as described herein and a composition containing organotin compounds having formula (1) and formula (2), which may, in some embodiments, be obtained by hydrolysis of a monoorgano tin compound having formula (1) as described herein. Additional aspects of the disclosure relate to films prepared from or containing a composition containing organotin compounds having formula (1) and (2).

The compounds described herein may be used as resist materials after hydrolysis or other reactions such as those known in the art. The compounds described herein may contain a group which is capable of forming an alkyltin oxo-hydroxo-patterning composition which may be hydrolyzed with water or other suitable reagents under suitable conditions to form an alkyltin oxo-hydroxo-patterning composition which may be represented by the formula R′SnO_{(3/2-x/2)}(OH)ₓ (0<x≤3). Hydrolysis and condensation reactions that may relate to a compound with hydrolytic groups (X) are shown in the following reactions:

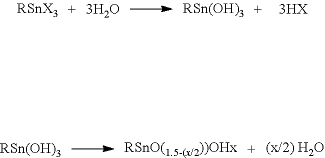

Alkyl oxohydroxy tin compounds obtained by hydrolysis using a composition containing R′SnX₃ compounds as described above as raw material and the oxohydroxy tin compounds represented by the formula R′SnO_{(3/2-x/2)}(OH)ₓ (0<x≤3) may be used as an EUV resist material.

A method for obtaining oxohydroxy tin compounds (R′SnO) by hydrolyzing a composition containing a R′SnX₃ compound may involve, for example, volatilizing a composition containing a R′SnX₃ compound under heating or reduced pressure, and reacting the vapor generated by volatilizing the composition on a substrate on which the tin composition is deposited, with water vapor, etc. (a dry method). In this method, a thin film containing the tin compound R′SnO may be formed on the substrate.

Another method may involve reacting a composition containing a R′SnX₃ compound in solution or in a solid state with water, etc., and hydrolyzing it to obtain the oxohydroxy tin compounds (R′SnO). The oxohydroxy tin compounds (R′SnO) may then be used as a coating solution by dissolving it in an organic solvent, for example. The organic solvent is not limited, however in particular, suitable solvents include, for example, aromatic compounds (e.g., xylenes, toluene), ethers (anisole, tetrahydrofuran), esters (propylene glycol monomethyl ether acetate, ethyl acetate, ethyl lactate), alcohols (e.g., 4-methyl-2-propanol, 1-butanol, methanol, isopropyl alcohol, 1-propanol), ketones (e.g., methyl ethyl ketone), halogen solvents (e.g., CH₂Cl₂, CHCl₃) and mixtures thereof. In general, organic solvent selection may be influenced by solubility parameters, volatility, flammability, toxicity, viscosity and potential chemical interactions with other processing materials.

The solution may be applied to a substrate by any coating or printing technique, and a thin film or coating containing oxohydroxy tin compounds (R′SnO) may be formed on the substrate. After the components of the solution are dissolved and combined, the character of the species may change as a result of partial hydration and condensation, especially during the coating process.

The thin film obtained by any of the above methods may be stabilized or partially condensed prior to light irradiation through drying, heating, or other processes. Generally, thin films or coatings have an average thickness of less than about 10 microns, and very thin submicron thin films, e.g., less than about 100 nanometers (nm), even less than about 50 nm or less than about 30 nm, may be desirable for patterning very small features. The resulting thin film or coating may be called a resist because the exposure processes a portion of the composition to be resistant to development/etching.

The thin or coating may be exposed to appropriate radiation, (e.g., extreme ultraviolet, electron beam, deep ultraviolet, or ultraviolet), using a selected pattern or negative portion of the pattern to form a latent image with developer resistant and developer soluble regions. After exposure to the appropriate radiation and prior to development, the thin film or coating may be heated or otherwise reacted to further differentiate the latent image from the non-irradiated areas. The latent image is brought into contact with the developer to form a physical image, i.e., a patterned thin film or coating. The patterned thin film or coating may be further heated to stabilize the remaining patterned coating on the surface. The patterned coating may be used as a physical mask to perform further processing according to the pattern, e.g., etching of the substrate and/or attachment of additional materials. After the patterned resist is used as requested, the remaining patterned coating may be removed at an appropriate point in the processing, but the patterned coating may also be incorporated into the final structure.

The invention will now be described in connection with the following, non-limiting examples.

### Example 1 (Prophetic): Synthesis of 2-Iodoethyl Tin Tri-tert-Butoxide

Vinyl tin trichloride is prepared according to method of Rosenberg and Gibbons (Journal of the American Chemical Society, 79, 2138-40 (1957)) by the redistribution reaction of tetravinyltin and tetrachlorotin. A flask is then charged with 400 mL of anhydrous THF and 189.08 g (0.75 moles) of vinyl tin trichloride and cooled to 0° C. under N₂. To the mixture, 25.5 mL (0.25 moles) of neat borane-methyl sulfide are added dropwise over 1 hour. The solution is warmed to room temperature and stirred for an additional two hours. Subsequently, 10 mL tert-butanol are added into the reactor to destroy traces of residual hydride. Under N₂, 190.5 g of iodine are added, followed by the dropwise addition of 0.75 moles of sodium tert-butoxide in tert-butanol solution over 30 min. The reaction mixture is stirred overnight, the solvents are removed under vacuum, and the crude product is distilled under vacuum to yield the title compound.

### Example 2 (Prophetic): Synthesis of 1,2-Diiodoethyl Tin Tri-tert-butoxide

A flask is charged with 400 mL of anhydrous acetonitrile or tert-butanol and 189.08 g (0.75 moles) of vinyl tin tri-tert-butoxide (prepared in-house) and cooled to 0° C. under N₂. To this mixture, 0.75 moles of I₂ are added. The solution is warmed to room temperature and stirred until the yellow color disappears. The solvents are removed under vacuum, and the crude product is distilled under vacuum to yield the title compound.

### Example 3 (Prophetic): Synthesis of 3-Iodoepropyl Tin Tri-tert-butoxide

Allyl tin trichloride is prepared according to method of Rosenberg and Gibbons (Journal of the American Chemical Society, 79, 2138-40 (1957)) by the redistribution reaction of tetraallyltin and tetrachlorotin. A flask is then charged with 400 mL of anhydrous THF and 189.08 g (0.75 moles) of allyl tin trichloride and cooled to 0° C. under N₂. To the mixture, 25.5 mL (0.25 moles) of neat borane-methyl sulfide are added dropwise over 1 hour. The solution is warmed to room temperature and stirred for an additional two hours. Subsequently, 10 mL tert-butanol are added into the reactor to destroy traces of residual hydride. Under N₂, 190.5 g of iodine are added, followed by the dropwise addition of 0.75 moles of sodium tert-butoxide in tert-butanol solution over 30 min. The reaction mixture is stirred overnight, the solvents are removed under vacuum, and the crude product is distilled under vacuum to yield the title compound.

### Example 4 (Prophetic): Synthesis of 1,2-Diiodopropyl Tin Tri-tert-butoxide

A flask is charged with 400 mL of anhydrous acetonitrile or tert-butanol and 189.08 g (0.75 moles) of vinyl tin tri-tert-butoxide (prepared in-house) and cooled to 0° C. under N₂. To this mixture 0.75 moles of I₂ are added. The solution is warmed to room temperature and stirred until the yellow color disappears. The solvents are removed under vacuum, and the crude product is distilled under vacuum to yield the title compound.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-8. (canceled)

9. A method of synthesizing a diiodoalkyl tin trialkoxide compound having formula (2): 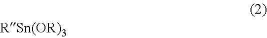
wherein R″ is primary or secondary iodoalkyl group having about 2 to about 10 carbon atoms and containing two iodine atoms and R is a primary, secondary, or tertiary alkyl group having about 1 to about 5 carbon atoms, the method comprising:
(a) providing a solution of an alkenyl tin trialkoxide; and
(b) adding solid iodine or an iodine solution to yield a product containing a diiodoalkyl tin trialkoxide having formula (2).

10. The method according to claim 9, wherein R″ is diiodoethyl, diiodopropyl, or diiodoisopropyl and R is ethyl, propyl, or isopropyl, t-butyl, or t-pentyl.

11. The method according to claim 9, wherein the compound having formula (2) has a purity of at least about 99 mol %.

12. The method according to claim 9, wherein the compound having formula (2) contains less than about 1 mol % bisdiiodoalkyl tin dialkoxide having formula (4):

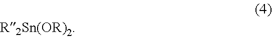

13. The method according to claim 9, wherein the solution in step (a) comprises acetonitrile or an alcohol solvent.

14. The method according to claim 9, wherein the solid iodine or the iodine solution is added at about 0° C. to about 10° C.

15. The method according to claim 9, further comprising after step (b):
(c) removing solvents under vacuum to produce a crude product.

16. The method according to claim 15, further comprising after step (c):
(d) distilling the crude product to yield the product containing diiodoalkyl tin trialkoxide having formula (2).

17. An iodoalkyl tin trialkoxide compound having formula (1): 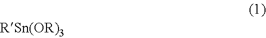
wherein R′ is a primary or secondary iodoalkyl group having about 2 to about 10 carbon atoms and containing at least one iodine atom and R is a primary, secondary, or tertiary alkyl group having about 1 to about 5 carbon atoms.

18. The iodoalkyl tin trialkoxide compound according to claim 17, wherein R′ is iodoethyl, iodopropyl, or iodoisopropyl and R is ethyl, propyl, isopropyl, t-butyl, or t-pentyl.

19. The iodoalkyl tin trialkoxide compound according to claim 17, having a purity of at least about 99 mol %.

20. The iodoalkyl tin trialkoxide compound according to claim 19, wherein the content of bisiodoalkyl tin dialkoxide having formula (3) is less than about 1 mol %.

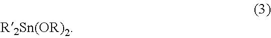

21. The iodoalkyl trialkoxide compound according to claim 17, wherein R′ contains at least one iodine atom substituted on a terminal carbon atom.

22. The iodoalkyl trialkoxide compound according to claim 17, wherein R′ contains at least one iodine atom substituted on a carbon atom which is at least two carbon atoms away from the tin atom.

23. The iodoalkyl trialkoxide compound according to claim 17, wherein R′ contains at least two iodine atoms.

24. The iodoalkyl trialkoxide compound according to claim 23, wherein the two iodine atoms are substituted on vicinal carbon atoms.

25. A diiodoalkyl tin trialkoxide compound having formula (2): 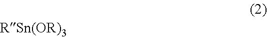
wherein R″ is a primary or secondary diiodoalkyl group having about 2 to about 10 carbon atoms and containing two iodine atoms and R is a primary, secondary, or tertiary alkyl group having about 1 to about 5 carbon atoms.

26. The diiodoalkyl tin trialkoxide compound according to claim 25, wherein R″ is iodoethyl, iodopropyl, or iodoisopropyl and R is ethyl, propyl, isopropyl, t-butyl, or t-pentyl.

27. The diiodoalkyl tin trialkoxide compound according to claim 25, having a purity of at least about 99 mol %.

28. The diiodoalkyl tin trialkoxide compound according to claim 27, wherein the content of bisdiiodoalkyl tin dialkoxide having formula (4) is less than about 1 mol %.

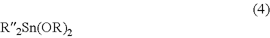

29. The diiodoalkyl tin trialkoxide compound according to claim 25, wherein R″ contains at least one iodine atom substituted on a terminal carbon atom.

30. The diiodoalkyl tin trialkoxide compound according to claim 25, wherein R″ contains at least one iodine atom substituted on a carbon atom which is at least two carbon atoms away from the tin atom.

31. The diiodoalkyl tin trialkoxide compound according to claim 30, wherein the two iodine atoms are substituted on vicinal carbon atoms.
